(19) United States
(12) Patent Application Publication
(10) Pub. No.: US 2008/0193851 A1
(43) Pub. Date: Aug. 14, 2008

(54) ALKALINE ELECTROCHEMICAL CELL HAVING IMPROVED GELLED ANODE

(75) Inventors: M. Edgar Armacanqui, Madison, WI (US); Andrew J. Roszkowski, Waunakee, WI (US)

Correspondence Address: Christopher M. Goff (27860);ARMSTRONG TEASDALE LLP, ONE METROPOLITAN SQUARE, SUITE 2600, ST. LOUIS, MO, 63102, US

(73) Assignee: ROVCAL, INC., Madison, WI (US)

(21) Appl. No.: 11/673,377

(22) Filed: Feb. 9, 2007

(51) Int. Cl. H01M 6/14

(52) U.S. Cl. 429/300

(57) ABSTRACT

The present disclosure relates generally to an alkaline electrochemical cell, such as a battery, and in particular to an improved gelled anode suitable for use therein. More specifically, the present disclosure relates to a gelled anode containing a highly crosslinked polyacrylic acid gelling agent that enables the benefits associated with an electrolyte having a relatively low hydroxide (e.g., potassium hydroxide) content, such as enhanced cell discharge performance, to be achieved, while avoiding the problems commonly associated with electrolytes having relatively low hydroxide content (e.g., an unacceptable level of cell gassing during discharge and/or a negative impact on discharge performance under certain load conditions including, for example, continuous load conditions).

### FIELD OF THE DISCLOSURE

The present disclosure relates generally to an alkaline electrochemical cell, such as a battery, and in particular to an improved gelled anode suitable for use therein. More specifically, the present disclosure relates to a gelled anode containing a highly crosslinked polyacrylic acid gelling agent that enables the benefits associated with an electrolyte having a relatively low hydroxide (e.g., potassium hydroxide) content, such as enhanced cell discharge performance, to be achieved, while avoiding the problems commonly associated with electrolytes having relatively low hydroxide content (e.g., an unacceptable level of cell gassing and/or a negative impact on discharge performance under certain load conditions including, for example, continuous load conditions).

### BACKGROUND OF THE DISCLOSURE

Alkaline electrochemical cells, commonly known as “batteries,” are used to power a wide variety of devices used in everyday life. For example, devices such as radios, toys, cameras, flashlights, and hearing aids all ordinarily rely on one or more electrochemical cells to operate. These cells produce electricity by electrochemically coupling, within the cell, a reactive gelled metallic anode, most commonly a zinc-containing gelled anode, to a cathode through a suitable electrolyte, such as a potassium hydroxide solution.

Zinc anode gels of alkaline electrochemical cells are prone to electrochemical corrosion reactions when stored at or above room temperature. The alkaline electrolyte in the anode gel corrodes the zinc anode upon contact, forming oxidized zinc products that decrease the availability of active zinc while simultaneously generating hydrogen gas. The rate of corrosion tends to increase as the electrolyte is made more dilute and as the storage temperature rises, which can lead to a significant decrease in cell capacity. Also, partial discharge of alkaline electrochemical cells generally leads to enhanced corrosion and cell gassing due to disruption of the native air-formed oxide barrier film that serves as a barrier to inhibit corrosion. Cell discharge performance, on the other hand, can be improved by making the electrolyte increasingly diluted. It is thus desirable to suppress gas generation (e.g., cell gassing) when using diluted alkaline electrolytes for increased performance.

Anode gels including electrolytes of relatively low hydroxide content have a corresponding relatively high proportion of water. The additional water provides an electrolyte solution that is more dilute and less basic, and aids in the following cathodic reaction:

2MnO₂+2H₂O+2e⁻→2MnOOH+2OH⁻ (for MnO₂ cell) (1)

Likewise, water may react to generate unwanted hydrogen gas as a result of the oxidation of zinc as part of the process of corrosion during cell storage. Also, lowering the hydroxide concentration in the electrolyte can cause the anode to become over-diluted and depleted in hydroxide ions which are needed to sustain the anodic cell reaction:

Zn+4OH⁻→Zn(OH)₄²⁻+2e⁻ (2)

The depletion of hydroxide ions can become prominent during medium and high continuous discharge rates and induce depressed cell performance due to anode failure in these cases. Furthermore, when the electrolyte is saturated with zincate Zn(OH)₄²⁻ produced in the above reaction (2), the zincate precipitates to form zinc oxide which, in turn, passivates the zinc anode, thereby lowering cell performance.

Conventional zinc powders contain particles having a wide distribution of particle sizes ranging from a few microns to about 1000 microns, with most of the particle size distribution ranging between 25 microns and 500 microns. To achieve proper discharge of such conventional zinc powders, a KOH concentration of the electrolyte above 34% is conventionally used. At lower concentrations, insufficient KOH is available to the anode and can lead to anode failure. Nevertheless, electrolytes of lower hydroxide concentrations are desired because of, in addition to the reasons noted above, the lower ionic resistance, which brings about higher cell operating voltage.

Additionally, hydrogen gas generated during corrosion reactions can increase the internal cell pressure, and thus cause electrolyte leakage and disrupt cell integrity. The rate at which the hydrogen gas is generated at the anode zinc surface accelerates when the battery is partially discharged, thereby decreasing the resistance of the battery to electrolyte leakage. The electrochemical corrosion reactions that lead to hydrogen evolution involve cathodic and anodic sites on the zinc anode surface. In particular, the corrosion reactions involve reduction of water at cathode sites and oxidation of zinc at anode sites. Such sites can include surface and bulk metal impurities, surface lattice features, grain boundary features, lattice defects, point defects, and inclusions.

In view of the foregoing, the need exists for a gelled anode having an electrolyte of a relatively low hydroxide (e.g., potassium hydroxide) content that provides the benefits associated therewith, but that avoids the known adverse effects, such as those associated with cell gassing.

### SUMMARY OF THE DISCLOSURE

In accordance with the present disclosure it has been discovered that a gelled anode including an electrolyte having a relatively low hydroxide (e.g., potassium hydroxide) content below that of a conventionally employed anode may be prepared that provides the advantages associated with relatively low hydroxide content of electrolytes (e.g., improved cell discharge performance), but that avoids the commonly known adverse effects associated therewith (e.g., cell gassing). In particular, it has been discovered that a gelled anode containing a highly crosslinked polyacrylic acid gelling agent, having one or more advantageous features detailed elsewhere herein, may be incorporated into a gelled anode to achieve these results.

Briefly, therefore, the present disclosure is directed to a gelled anode mixture comprising a crosslinked polyacrylic acid gelling agent, an anode active material, and an alkaline electrolyte, wherein the gelled anode mixture has a viscosity of between at least about 300,000 centipoise (cp) and less than about 500,000 cp at 25° C.

The present disclosure is also directed to a gelled anode mixture comprising a crosslinked polyacrylic acid gelling agent, an anode active material, an alkaline electrolyte, and an absorbent material, wherein the gelling agent and the absorbent material are present in the gelled anode mixture at a weight ratio of at least 3:1.

The present disclosure is further directed to one or more of the above-noted gelled anode mixtures, wherein the alkaline electrolyte has a hydroxide concentration, and in particular a potassium hydroxide concentration, of less than about 35 weight percent, or less than about 30 weight percent, based on the total anode weight.

The present disclosure is further directed to one or more of the above-noted gelled anode mixtures, wherein anode active materials present therein comprises zinc.

The present disclosure is still further directed to an alkaline electrochemical cell comprising: (i) a cathode; (ii) one of the above-noted gelled anode mixtures; and, (iii) a separator between the cathode and the anode.

Other objects and features will be in part apparent and in part pointed out hereinafter.

### BRIEF DESCRIPTION OF THE DRAWINGS

FIG. 1 shows a cross section of an exemplary electrochemical cell in an open configuration including, among other things, a cathode, an anode, and a separator.

FIGS. 2 and 3 show the results of discharge performance testing of electrochemical cells of the present disclosure as described in Example 1.

FIGS. 4 and 5 show the results of discharge performance testing of electrochemical cells of the present disclosure as described in Example 2.

FIGS. 6 and 7 show the results of partial discharge cell gassing testing of electrochemical cells of the present disclosure as described in Example 3.

FIGS. 8 and 9 show the results of discharge performance testing of electrochemical cells of the present disclosure as described in Example 4.

FIGS. 10-13 show the results of discharge performance testing of electrochemical cells of the present disclosure as described in Example 5.

FIG. 14 shows the results of partial discharge cell gassing testing of electrochemical cells of the present disclosure as described in Example 6.

FIG. 15 shows the results of Digital Still Camera (DSC) testing for cells of the present disclosure as described in Example 4.

FIG. 16 shows the results of viscosity testing of various gelled anodes as described in Example 8.

### DETAILED DESCRIPTION OF THE DISCLOSURE

It is known that gelled anodes having a relatively low hydroxide content, and more specifically gelled anodes having an electrolyte with a relatively low hydroxide (e.g., potassium hydroxide) content, such as for example a hydroxide content in the electrolyte of less than about 35%, 30% or less (e.g., about 29%, about 28%, about 27%, about 26%, about 25%, or even less), based on the total electrolyte weight, provide certain advantages, such as improved cell performance (e.g., improved ANSI performance, as determined using means known in the art). However, it is also known that a gelled anode having an electrolyte with a relatively low hydroxide content is typically met with various disadvantages, including for example: (i) relatively high, and often unacceptable, levels of cell gassing during discharge (i.e., under partial discharge conditions); and/or (ii) a concentration of hydroxide ions which is insufficient, for purposes of sustaining the anodic reaction.

In response to the above-noted issues and concerns, and in accordance with the present disclosure, it has been discovered that, by means of the proper selection of a gelling agent to be used therein, a gelled anode having a relatively low hydroxide content, or more specifically a gelled anode having an electrolyte with a relatively low hydroxide content, may be prepared that provides the benefits attendant a relatively low hydroxide content, but that limits, and desirably avoids, the disadvantages commonly associated with a gelled anode having an electrolyte with a low hydroxide content. In particular, it has been discovered that such a gelled anode may be prepared by using a crosslinked, polyacrylic acid gelling agent that has one or more advantageous properties, including, as compared to conventional crosslinked, polyacrylic acid gelling agents, (i) a higher degree of crosslinking, (ii) a higher viscosity, and/or (iii) greater swelling capabilities (when used in an anode gel). The gelled anodes prepared utilizing such gelling agents may exhibit a higher viscosity (initially upon preparation of the gelled anode and/or after storage of the gelled anode), as compared to conventional gelled anodes (as further detailed elsewhere herein).

In this regard it is to be noted that the viscosities of gelling agents reported herein are with reference to the viscosity of a 0.5 wt. % aqueous solution of the gelling agent and may be measured using means conventionally known in the art including, for example, using a viscometer commercially available from Brookfield Engineering Laboratories, Inc. (Middleboro, Mass.) under standard conditions. For example, a RVT Brookfield viscometer using a No. 5 spindle and operated at 1 revolution per minute (rpm) may be used to measure the viscosity of aqueous solutions containing gelling agents of the present disclosure. This and other suitable apparatus may also be used to measure the viscosity of gelled anodes of the present disclosure.

### I. General Electrochemical Cell Structure

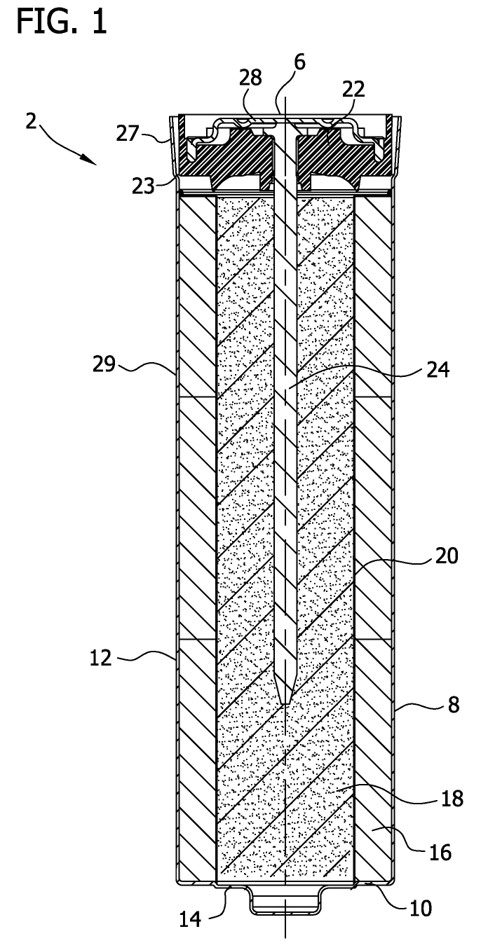

Referring now to FIG. 1, an electrochemical cell is shown in the form of an AA-size cylindrical cell battery and is generally indicated at 2. It is contemplated, however, that the electrochemical cell of the present disclosure has application to other sized batteries (e.g., A-, AAA-, C- and D-), as well as to non-cylindrical cells, such as flat cells (e.g., prismatic cells and button cells) and rounded flat cells (e.g., having a racetrack cross-section). The cylindrical cell configuration shown in FIG. 1 has a positive terminal 14, a negative terminal 6, and a positive current collector in the form of an electrically conductive cylindrical container 8. In the illustrated electrochemical cell, a single piece formed container 8 may be of drawn steel having a closed bottom formed by an end wall 10 and a cylindrical side wall 12 formed as one piece with the end wall 10. The positive terminal 14 is thus defined by the end wall 10 of the metal container 8 in the illustrated embodiment. However, in alternative embodiments, the end wall may be flat and have a positive terminal plate (not shown) attached thereto as by welding to define the positive terminal 14 without departing from the scope of this disclosure. The opposite end of the container 8 is generally open. As used herein the term “side wall” refers not only to a wall like the illustrated cylindrical wall 12 having a single, continuous curve, but also to side walls (not shown) having other shapes including those formed from multiple flat wall sections.

Contained in the container is a cathode 16 comprised of one or more annular rings formed of a suitable cathode material which defines an open center along the longitudinal direction of the container. The cathode 16 may suitably have an outer diameter that is slightly greater than the inner diameter of the container side wall 12, to provide a tight fit upon insertion of the cathode into the container 8. A suitable coating, such as carbon, may be applied to the inner surface of the container side wall 12 to enhance electrical contact between the cathode 16 and the container 8. The cathode may comprise any number of various components, including for example an oxide of copper (such as disclosed in co-assigned U.S. patent application Ser. Nos. 10/914,934 and 11/354,729, the entire contents of which are incorporated herein by reference for all relevant purposes, to the extent it is consistent with the present disclosure), manganese dioxide (e.g., electrolytic magnesium dioxide), or other suitable cathode materials.

Also contained in the container of FIG. 1 is a gelled anode 18, as further detailed elsewhere herein, which is located on the inner diameter of a separator 20 so that the separator physically separates the gelled anode 18 from the cathode 16. The gelled anode 18, as further detailed elsewhere herein, can be formed in any suitable manner, and may suitably comprise a mixture including an anode metal (e.g., zinc) provided as a powder, an aqueous alkaline electrolyte and a highly crosslinked, polyacrylic acid gelling agent. Examples of anode 18 formulations, which may be generally suitable for use in accordance with the present disclosure, are further detailed elsewhere herein, as well as in, for example, co-assigned U.S. Pat. No. 6,040,088 (the entire content of which is incorporated herein by reference for all relevant purposes, to the extent it is consistent with the present disclosure). Additional electrolyte (not shown) may be added to the container 8 during fabrication to further, or partially, wet the anode 18, the cathode 16 and the separator 20. Suitable electrolytes include, for example, potassium hydroxide, sodium hydroxide, and/or lithium hydroxide, in an alkaline battery, but other compositions can be used without departing from the scope of the present disclosure.

To finally assemble the electrochemical cell, the cathode 16, separator 20 and anode 18 are loaded into the container 8 with the container in its open configuration as shown. A sealing assembly 22, negative current collector 24 and negative terminal plate 28 are placed in the open upper end of the container 8 with the sealing assembly 22 seating on the shoulder 23 formed at the junction of the upper and lower extents 27, 29 of the container and the negative terminal plate 28 seated on the shoulder formed in the sealing assembly 22.

It is to be noted that the term “longitudinal”, as used herein, refers to the general direction extending from one end of the container 8 to the other, regardless of whether the greatest dimension of the container is in the longitudinal direction. The terms “lateral,” “transverse” and “radial” refer to a general direction extending perpendicular to the longitudinal direction so as to extend through the side wall 12 of the container 8. In particular, where the term radial is used herein in reference to annular or circular shaped elements, it is understood that the terms lateral and transverse may be substituted for the radial components that are other than annular or circular.

It is to be further noted that the electrochemical cell of the present disclosure is typically illustrated in a generally vertical orientation, with the positive terminal at the bottom and the negative terminal at the top. Accordingly, use of terms herein such as top, bottom, upper and lower, are in reference to positions along the longitudinal direction of the cell 2 (e.g., of the container 8), while the use of terms such as inner and outer are in reference to positions along the transverse or radial direction.

### II. Gelled Anode

As previously noted, the present disclosure is generally directed to a gelled anode, and/or an electrochemical cell comprising such a gelled anode, which comprises a gelling agent (as further detailed elsewhere herein), an alkaline electrolyte (e.g., an aqueous potassium hydroxide solution), and an anode active material (e.g., a material typically comprising zinc). The gelling agent is present in the anode, at least in part, to add mechanical structure and/or to coat the metallic particles to improve ionic conductivity within the anode during discharge. The preparation of the gelled anode is further detailed elsewhere herein; generally speaking, however, the gelled anode may be prepared by preparing an electrolyte, preparing a coated metal anode which includes the gelling agent, and then combining the electrolyte and the coated metal anode to form a gelled anode.

In this regard it is to be noted that, as used herein, “gelled anode” (as well as variations thereof) generally refers to the anode once the electrolyte (or in some instances the remaining portion of the electrolyte) has been added or introduced thereto. In contrast, a “coated metal anode” (as well as variations thereof) generally refers to the anode prior to addition or introduction of the electrolyte thereto (or the full amount of the electrolyte thereto).

A. Gelling Agent

Without being held to any particular theory, it is generally believed that one or more characteristics of the gelling agent (e.g., the density or viscosity thereof) utilized in accordance with the present disclosure contribute, at least in part, to its suitability for use in a gelled anode, particularly one having a relatively low potassium hydroxide content. More specifically, it is generally believed that the highly crosslinked gelling agent imparts a rigid-type gel structure and a slightly decreased packing density to the gelled anode within the cell, as well as a corresponding greater but more stable anode particle-to-particle distance than provided by conventional gelling agents. These features of the anode gels are believed to contribute to improved reactant transport and wettability throughout the anode gel, enhancing cell discharge performance. In particular, the gelled anode of the present disclosure is believed to contribute to improved transport of hydroxyl ions throughout the anode mass during cell discharge, which is generally preferred under certain conditions including, for example, high rate, continuous discharge. As further detailed elsewhere herein, various features of the gelling agent may be indicators of the suitability of these gelling agents for use in a gelled anode having relatively low potassium hydroxide content, including for example the degree of crosslinking in the gelling agent, and/or the viscosity and/or density thereof.

Generally speaking, the gelling agent of the present disclosure is a highly crosslinked, polymeric chemical compound that has negatively charged acid groups. The function of these acid groups is to expand the polymer backbone into an entangled matrix. When these acid groups are ionized in the anode, they repel each other and the polymer matrix swells to provide a support mechanism. One gelling agent particularly well-suited for use in accordance with the present disclosure is a polyacrylic acid gelling agent having a high degree of crosslinking therein, or a degree of crosslinking which is greater than that present in conventionally employed gelling agents (such as for example those commercially available under the name Carbopol™). In particular, more highly crosslinked polyacrylic acid gelling agents, commercially available under the name Flogel™ (e.g., Flogel™ 700 or 800) from SNF Holding Company (Riceboro, Ga.), are suitable for use in accordance with the present disclosure.

In addition to the increased degree of crosslinking present in the gelling agent (as compared, for example, to those commercially available under the name Carbopol™), additional advantageous features of the gelling agent are its viscosity and/or density. Generally speaking, the viscosity and/or the density of the gelling agent utilized in the present disclosure is/are greater than that of conventionally employed gelling agents. For example, the viscosity of suitable gelling agents at about 25° C. is generally at least about 40,000 centipoise (cp), at least about 45,000 cp, at least about 50,000 cp, or at least about 55,000 cp. In accordance with certain embodiments of the present disclosure, however, the viscosity of suitable gelling agents is at least about 58,000 cp, about 60,000 cp, about 62,000 cp, about 64,000 cp, about 66,000 cp, about 68,000 cp, or even about 70,000 cp. Accordingly, the viscosity of suitable gelling agents may generally range, for example, from about 50,000 cp to about 70,000 cp, from about 60,000 cp to about 68,000 cp, or from about 62,000 cp to about 66,000 cp, at about 25° C.

As previously noted, the viscosities of gelling agents reported herein are with reference to the viscosity of a 0.5 wt. % aqueous solution of the gelling agent and may be measured using means conventionally known in the art including, for example, using a viscometer commercially available from Brookfield Engineering Laboratories, Inc. (Middleboro, Mass.) under standard conditions. For example, a RVT Brookfield viscometer having a No. 5 spindle and operated at 1 revolution per minute (rpm) may be used to measure the viscosity of aqueous solutions containing gelling agents of the present disclosure. This and other suitable apparatus may also be used to measure the viscosity of gelled anodes of the present disclosure.

With respect to the bulk density of suitable gelling agents (i.e., the density of the gelling agent in powder form), it is to be noted that this is generally at least 0.21 grams/cubic centimeter (g/cc), and may be at least 0.22 g/cc, at least 0.23 g/cc, at least 0.24 g/cc, at least 0.25 g/cc or more (e.g., about 0.26, 0.28, 0.3 or more g/cc). Typically, however, the density of suitable gelling agents is from 0.22 g/cc to about 0.3 g/cc, or from 0.24 g/cc to about 0.28 g/cc. In this regard it is to be noted that the bulk density of gelling agents of the present disclosure may be determined using means and apparatus known in the art including, for example, the method described in ASTM C29/C29M-97(2003), but generally are determined by measuring the mass of a predetermined volume of the gelling agent. The bulk density of gelled anodes of the present disclosure may generally be determined in the same or a similar manner.

The concentration of the gelling agent in the anode, and more specifically the gelled anode, may be optimized for a given use. Typically, however, the concentration of the gelling agent in the gelled anode is at least about 0.40 weight %, based on the total weight of the gelled anode, and may be at least about 0.50 weight %, at least about 0.55 weight %, at least about 0.6 weight %, at least about 0.625 weight %, at least about 0.65 weight %, at least about 0.675 weight %, at least about 0.7 weight % or more. For example, in various embodiments the concentration of the gelling agent in the gelled anode may be from about 0.40% to about 0.75%, or between about 0.50% and 0.75%, or between about 0.6% and about 0.7%, or between about 0.625% and about 0.675%, by weight of the gelled anode. In one particular embodiment, the concentration is about 0.60 weight % (when for example it is used in combination with an absorbent as a gelled anode component), while in another embodiment the concentration is between about 0.62 and about 0.66 weight % (when for example it is used without an absorbent as a gelled anode component).

In addition to the degree of crosslinking, the viscosity and/or density, the gelling agent of the present disclosure may also be characterized by the flow properties (e.g., viscosity) and/or the density of the gelled anode of which it is a part. For example, with respect to the flow properties of the gelled anode, it is to be noted that, in addition to increased viscosity of the gelling agent of the present disclosure (as compared to a conventional gelling agent), the viscosity of freshly-made gelled anodes of the present disclosure containing such an agent may, in at least some embodiments, typically be greater than that of a freshly-made, conventional gelled anode. Generally, the initial viscosity of freshly-made gelled anodes of the present disclosure at 25° C. is at least about 60,000 cp, at least about 80,000 cp, or at least about 100,000 cp. More particularly, the initial viscosity of freshly-made gelled anodes of the present disclosure at 25° C. is typically at least about 120,000 cp, at least about 160,000 cp, at least about 180,000 cp, at least about 200,000 cp, at least about 240,000 cp, at least about 280,000 cp, or at least about 300,000 cp. For example, the initial viscosity of a gelled anode of the present disclosure at 25° C. may be in the range of from about 120,000 cp to about 360,000 cp, from about 160,000 cp to about 320,000 cp, from about 180,000 cp to about 300,000 cp, from about 200,000 cp to about 280,000 cp, or from about 220,000 cp to about 260,000 cp.

In this regard, it is noted that “initial” viscosity of a freshly-made gelled anode refers to viscosity of the gelled anode determined before storage of the anode for any significant period of time. In particular, initial viscosity refers to the viscosity of the gelled anode determined within about 15 minutes of its preparation, within about 30 minutes of its preparation, within about 45 minutes of its preparation, or within about 60 minutes of its preparation.

As a result of the viscosity of the gelling agent of the present disclosure, an anode gel prepared using this gelling agent is typically more rigid than a gel prepared using a conventional gelling agent, particularly after being stored for a period of time. For example, using means known in the art, it may be observed that a conventionally prepared anode gel (e.g., one prepared using a similar amount of, for example, a Carbopol™ agent, such as Carbopol™ 940) may exhibit an initial viscosity (i.e., a viscosity measured immediately after preparation) similar to the initial viscosity of the gelled anode of the present disclosure. In contrast, however, while the conventionally prepared gelled anode may exhibit little change in viscosity after having been prepared and stored at room temperature (e.g., about 20-25° C.) for a period of time, the gelled anode of the present disclosure may, after having been stored at about room temperature for essentially the same period of time (e.g., at least about 8 hours, about 12 hours, about 18 hours or even about 24 hours), exhibits a viscosity that has increased, relative to the initial viscosity, by at least about 20%, at least about 30%, at least about 40%, at least about 50%, at least about 60%, at least about 70%, or at least about 80%. For example, in various embodiments, the viscosity of the gelled anode of the present disclosure may increase after storage by from about 20% to about 80%, from about 30% to about 70%, from about 40% to about 60%, or from about 45% to about 55%.

It is to be further noted that, in accordance with the above description of initial viscosities of gelled anodes of the present disclosure, and viscosities after storage, it has been observed that before and/or after incorporation into an electrochemical cell, gelled anodes of the present disclosure generally exhibit a viscosity of at least about 300,000 cp, at least about 310,000 cp, at least about 320,000 cp, at least about 330,000 cp, at least about 340,000 cp, at least about 350,000 cp, at least about 360,000 cp, at least about 370,000 cp, at least about 380,000 cp, at least about 390,000 cp, at least about 400,000 cp, at least about 410,000 cp, at least about 420,000 cp, or more. Typically, however, gelled anodes of the present disclosure exhibit a viscosity of between at least about 300,000 cp and less than 500,000 cp, of from about 310,000 cp to about 475,000 cp, from about 320,000 cp to about 450,000 cp, from about 330,000 cp to about 425,000 cp, from about 340,000 cp to about 400,000 cp, or from about 350,000 cp to about 375,000 cp

The density of the gelled anode of the present disclosure is generally less than about 3.5 g/cc, less than about 3.3 g/cc, less than about 3.1 g/cc, or less than about 3.0 g/cc. Typically, however, the density of the gelled anode in accordance with the present disclosure is at least about 2.5 grams/cubic centimeter (g/cc), at least about 2.6 g/cc, at least about 2.7 g/cc, or at least about 2.8 g/cc. For example, in various embodiments the density of a suitable gelled anode may be in the range of from about 2.5 g/cc to about 3.5 g/cc, from about 2.6 g/cc to about 3.3 g/cc, from about 2.7 g/cc to about 3.1 g/cc, or from 2.8 g/cc to about 3 g/cc.

It is to be noted that viscosities and densities of the gelled anode reported herein may be determined using conventional means known in the art (including, for example, the apparatus described above for use in measuring the viscosity of gelling agents of the present disclosure).

B. Anode Active Material and Electrolyte

The type and/or concentration of the anode active material, and/or the electrolyte, may generally be selected from those known in the art, in order to optimize performance of the alkaline electrochemical cell of which this gelled anode is a part. Suitable anode active materials and electrolytes, as well as concentrations thereof, are noted in, for example, U.S. patent application Ser. No. 11/354,729 (the entire content of which is incorporated herein by reference for all relevant purposes, to the extent it is consistent with the present disclosure).

Zinc is generally the most common anode active material, which may be used alone or in combination with one or more other metals. Furthermore, it is typically used in the form of an alloy powder. For example, in one or more embodiments one of ordinary skill in the art may readily select a suitable powder comprising zinc mixed with, or alloyed with, one or more other metals known in the art (e.g., In, Bi, Ca, Al, Pb, etc.). Accordingly, in this regard it is to be noted that, as used herein, “zinc” may refer to a zinc particle or powder alone, or one that has been optionally mixed or alloyed with one or more other metals. Zinc particles may be present in a variety of forms including, for example, elongated, round, as well as fiber-like or flake-like particles.

It is to be noted, however, that the type and/or concentration of the anode active material, and/or the electrolyte, may be affected by the selections made with respect to the other components of the electrochemical cell, such as for example the cathode. For example, conventional cathodes, such as those having MnO₂ as an active ingredient, may consume more water by the cathodic reaction than is provided by the electrolyte. The zinc anodes of conventional alkaline cells are thus generally limited to a zinc concentration, or loading, that is below about 70 wt %, based on the weight of the anode, because higher zinc loadings may not discharge efficiently, as the anode would not contain sufficient quantities of electrolyte to properly sustain the water consuming reaction in the cathode. Furthermore, high zinc loadings with conventional particle size distributions result in higher mass transfer polarization due to the low porosity of these anodes, leading to early anode passivation and premature failure.

Conventional zinc powders may contain particles having a wide distribution of particle sizes, which range for example from a few microns (e.g., about 5 microns, about 10 microns, about 15 microns, about 25 microns or up) up to about 500 microns, about 750 microns or even about 1000 microns. Typically, however, most of the particles of the zinc powder fall within a size distribution ranging between about 25 microns and about 500 microns.

It is to be noted that, in contrast to electrolytes utilized in conventional anodes, electrolytes having a hydroxide (e.g., potassium hydroxide) concentration of less than about 35%, 30% or less (e.g., about 29%, about 28%, about 27%, about 26%, or even about 25%), are suitable for use when, in accordance with the present disclosure, the gelling agent detailed herein is employed. Additionally, it may be advantageous to employ zinc which has a smaller particle size, and/or a narrower particle size distribution. For example, it may be useful in one or more embodiments of the disclosure if the zinc particles having a size distribution wherein at least about 70%, about 75%, about 80%, about 85%, about 90%, about 95% or even about 100% of the particles have a standard mesh-sieved particle size that is within about ±200 microns, about ±150 microns, about ±100 micron size range or less (e.g., about 90 microns, about 70 microns, about 50 microns or less) of a given target particle size (e.g., about 50 microns, about 100 microns, about 150 microns, about 200 microns, about 250 microns, or about 300 microns). For example, in one or more embodiments, it may be advantageous to use zinc particles wherein between about 90% and 95%, or even about 100%, of the particle sizes, by weight, are within about a 200, 150, or even 100 microns of a target particle size of about 50 microns, about 100 microns, about 150 microns, about 200 microns, about 250 microns, or about 300 microns.

In this regard one skilled in the art will recognize that mesh sizes corresponding to these particle sizes can be identified using ASTM Designation B214-99. An anode containing zinc particles having a more narrow particle size distribution, such as those noted above, may be well-suited for use in combination with, for example, a copper oxide-containing cathode, as detailed elsewhere herein, because such a cathode is one example of a cathode that consumes less water than alkaline manganese dioxide cells. Such an anode may be “drier” than conventional electrochemical cells, meaning that the anode has a higher loading of zinc particles that can be efficiently discharged with reduced electrolyte concentrations. Such an anode/cathode combination may be particularly advantageous because, due to the copper oxide, or a mixed copper oxide, active material in the cathode is low-water consuming, and thus the amount of electrolyte required in the anode may be reduced relative to a conventional zinc manganese dioxide alkaline cell. The low-water consuming reaction advantageously permits an increase in zinc loading in the anode and thereby facilitates a longer cell service life.

Another factor that may impact cell performance relates to the surface area of the anode, with smaller particles typically increasing the effective surface area of the anode. More specifically, increasing the active anode electrode surface area provides sufficient active reaction sites needed to keep up with the cathode reaction at high discharge rates. Accordingly, it is desirable to provide cells having a predetermined amount of zinc particles, which may either be in the form of zinc or a zinc alloy. The concentration of zinc in the anode may vary for a given application, and/or electrochemical cell configuration. Typically, however, the total amount of zinc present in the anode, or more generally the amount of anode active material, is at least about 50 wt %, about 60 wt %, about 70 wt %, or about 80 wt %, the concentration for example being between about 50 wt % and about 80 wt %, between about 55 wt % and about 75 wt %, or between about 60 wt % and about 70 wt % (e.g., about 64 wt %, about 66 wt %, or about 68 wt %), based on the total weight of the anode.

As noted herein, this zinc may have a range of particle sizes, and/or particle size distributions. For example, the anode may comprise zinc particles having a particle size of less than about 75 microns (−200 mesh size), which may be referred to herein as “zinc fines.” In particular, zinc particles that pass through a 200 mesh screen size, and thus have a particle size of less than about 75 microns, may be present in the anode in an amount of, for example, less than about 10 wt % or about 5 wt %, relative to the total zinc in the anode (including coarse zinc particles, or zinc particles having a particle size of greater than about 75 microns), and in some embodiments may be present in the anode in an amount of between about 1 wt % and about 10 wt %, or between about 2 wt % and about 8 wt %, or between about 3 wt % and about 6 wt %.

It is to be noted that mesh sizes are stated herein to specify a range of particle sizes. For example, “−200 mesh” generally indicates particles smaller than about 75 microns, while “+200 mesh” generally indicates particles larger than about 75 microns.

It is to be further noted that, additionally or alternatively, desirable results may also be achieved using an amount of zinc fines greater than about 10 wt % (e.g., about 20 wt %, about 30 wt %, about 40 wt %, or even about 50 wt %), based on the total weight of zinc present in the anode. The use of zinc fines may be particularly useful when, for example, the particle size of the other zinc particles (i.e., coarse zinc particles) being used is, for example, between about 75 and about 105 microns (+75 and −140 mesh size). These coarse zinc particles may be present in an amount between, for example, about 1 wt % and about 50 wt %, or between about 10 wt % and about 40 wt %, based on the total weight of zinc present in the anode.

It is to be still further noted that multiple ranges of zinc particles having a diameter less than about 105 microns (−140 mesh size), including particles between about 75 and about 105 microns (+200 and −140 mesh size) and zinc fines less than about 75 microns (−200 mesh size), may be used to increase cell performance. For instance, the anode may include zinc particles between about 75 and about 105 micrometers, with the advantages in cell performance being enhanced when the anode gel has a low electrolyte concentration, as detailed elsewhere herein. When zinc fines have a size between the range of about 20 and about 75 micrometers (+625 and −200 mesh size), or alternatively between about 38 and about 75 micrometers (+400 and −200 mesh size), cell performance may be particularly enhanced when the electrolyte concentration is low, as detailed elsewhere herein.

With respect to the type and concentration of the electrolyte in the gelled anode, as previously noted, the gelled anode of the present disclosure includes an alkaline electrolyte, and more particularly an alkaline electrolyte having a relatively low hydroxide content. Suitable alkaline electrolytes include, for example, aqueous solutions of potassium hydroxide, sodium hydroxide, lithium hydroxide, as well as combinations thereof. In one particular embodiment, however, a potassium hydroxide-containing electrolyte is used.

Also as previously noted, electrolytes utilized in accordance with the present disclosure typically have a hydroxide (e.g., potassium hydroxide) concentration of about 35%, about 30% or less (e.g., about 29%, about 28%, about 27%, about 26%, or even about 25%), based on the total electrolyte weight. However, typically the electrolyte has a hydroxide concentration of between about 25% and about 35%, or between about 26% and about 30%. In one particular embodiment (e.g., a gelled anode suitable for use in a cell sized and shaped as, for example, an AA or AAA cell), the hydroxide concentration of the electrolyte is about 28% by weight, based on the total weight of the electrolyte.

In this regard it is to be noted that the concentration of the relatively low hydroxide content electrolyte in the gelled anode is generally at or near that of conventional gelled anodes, the concentration for example typically being at least about 24% by weight, at least about 26% by weight, or at least about 28% by weight, and less than about 34% by weight, less than about 32% by weight, or less than about 30% by weight, based on the total weight of the gelled anode. The concentration of the electrolyte in gelled anodes of the present disclosure may, therefore, typically be within the range of from about 24% by weight to about 34% by weight, from about 26% by weight to about 32% by weight, or from about 28% by weight to about 30% by weight, based on the total weight of the gelled anode. The desired concentration of electrolyte in the gelled anode generally depends on a variety of factors including, for example, the concentration of zinc in the gelled anode.

C. Additional Anode Components

A gelled anode of the present disclosure may also employ other components or additives, in addition to the gelling agent and the anode active material and the electrolyte. For example, in one particular embodiment, an absorbent (e.g., superabsorbent) is employed. Without being held to any particular theory, it is generally believed that these materials generally absorb and retain water in the gelled anode and allow electrolyte to be retained near the anode active material (e.g., zinc); that is, the absorbent is believed to function as an electrolyte reservoir. It is also believed that absorbent material promotes contact between anode active material particles and promotes formation of a gelled anode in which these particles are in better electrical contact. When an absorbent material is present in the gelled anode, any or all of these features of the absorbent material are believed to enhance the performance of the gelled anode.

Suitable absorbent materials may be selected from those generally known in the art. Exemplary absorbent materials include those sold under the trade name Salsorb™ or Alcasorb™ (e.g., Alcasorb™ CL15), which are commercially available from Ciba Specialty (Carol Stream, Ill.), or alternatively those sold under the trade name Sunfresh™ (e.g., Sunfresh DK200VB), commercially available from Sanyo Chemical Industries (Japan). Absorbent materials described, for example, in U.S. Pat. Nos. 5,686,204 and 6,040,088 (the entire contents of which are incorporated herein by reference for all relevant purposes, to the extent it is consistent with the present disclosure), may also be used in the gelled anodes of the present disclosure, alone or in combination with other absorbent materials.

Advantageously, the gelling agent of the present disclosure enables a reduced amount (e.g., about 30%, about 50% or even about 70% less) of an absorbent to be used to prepare a gelled anode, as compared for example to a conventional gelled anode and a gelling agent, to thereby reduce the cost of the gelled anode. For example, generally the concentration of absorbent in gelled anodes of the present disclosure is less than about 0.2%, less than about 0.15%, less than about 0.125%, less than about 0.1%, less than about 0.075%, less than about 0.05%, less than about 0.025%, or even less than about 0.01%, of the total anode weight. Typically, however, the concentration of absorbent in the gelled anode of the present disclosure is from about 0.01% to about 0.2% by weight, from about 0.025% to about 0.15% by weight, or from about 0.05% to about 0.1% by weight. For example, in various embodiments the gelled anode may comprise 0.04 wt %, or about 0.05 wt %, or about 0.06 wt %, of an absorbent material.

As a result of the reduced concentration of absorbent, and/or the increased concentration of gelling agent, present in the gelled anode of the present disclosure, the weight ratio of the gelling agent to absorbent therein is generally greater than that associated with conventional gelled anodes. For example, in various embodiments the ratio of gelling agent to absorbent may be at least 3:1, at least about 3.5:1, at least about 4:1, at least about 5:1, at least about 7.5:1, at least about 10:1, or at least about 12.5:1. Typically, the ratio of gelling agent to absorbent is from at least 3:1 to about 25:1, from about 4:1 to about 22.5:1, from about 5:1 to about 20:1, from about 7.5:1 to about 17.5:1, or from about 10:1 to about 15:1.

In this regard it is to be noted that the concentration of the gelling agent and/or the absorbent may be adjusted for a given use, as a function of for example the electrolyte (e.g., potassium hydroxide) and/or zinc concentration, the desired flow properties (e.g., viscosity) and/or density.

In particular, it is to be noted that the concentration of the gelling agent in the gelled anode, the concentration of absorbent in the gelled anode, and the relative proportion of these two components of the gelled anode, may be inter-related and thus work in combination to affect the viscosity of the gelling agent. Accordingly, among the various embodiments of the present disclosure, the following exemplary combinations may be noted: (i) when the viscosity of the gelled anode is between at least about 300,000 cp and less than about 500,000 cp, the concentration of the gelling agent in the anode may typically be from about 0.40% to about 0.75%, the concentration of the absorbent in the gelled anode may typically be from about 0.01% to about 0.2% by weight, and/or the weight ratio of the gelling agent to the absorbent may typically be from 3:1 to about 25:1; (ii) when the viscosity of the gelled anode is between about 310,000 cp to about 475,000 cp, the concentration of the gelling agent in the gelled anode may typically be from about 0.40% to about 0.75%, the concentration of the absorbent in the gelled anode may typically be from about 0.01% to about 0.2% by weight, and/or the weight ratio of the gelling agent to absorbent may typically be from about 4:1 to about 22.5:1; (iii) when the viscosity of the gelled anode is from about 320,000 cp to about 450,000 cp, the concentration of the gelling agent in the gelled anode may typically be between about 0.50% and 0.75%, the concentration of the absorbent in the gelled anode may typically be from about 0.01% to about 0.2% by weight, and/or the weight ratio of the gelling agent to the absorbent may typically be from about 5:1 to about 20:1; (iv) when the viscosity of the gelled anode is from about 330,000 cp to about 425,000 cp, the concentration of the gelling agent in the gelled anode may typically be between about 0.6% and about 0.7%, the concentration of the absorbent in the gelled anode may typically be from about 0.025% to about 0.15% by weight, and/or the weight ratio of the gelling agent to the absorbent may typically be from about 7.5:1 to about 17.5:1; and/or (v) when the viscosity of the gelled anode is from about 340,000 cp to about 400,000 cp, the concentration of the gelling agent in the gelled anode may typically be between about 0.625% and about 0.675%, the concentration of the absorbent in the gelled anode may typically be from about 0.05% to about 0.1% by weight, and/or the weight ratio of the gelling agent to the absorbent may typically be from about 10:1 to about 15:1.

In addition to an absorbent material, the gelled anode may additionally or alternatively comprise a corrosion or gassing inhibitor (e.g., organic inhibitor). Suitable corrosion or gassing inhibitors may be selected from those generally known in the art, including for example phosphate-type corrosion or gassing inhibitors (e.g., RM510, which is commercially available from Adco (Sedalia, Mo.)), and/or amphoteric-type inhibitors (e.g., Mafo Mod 13, which is commercially available from BASF (Mount Olive, N.J.)). Suitable corrosion or gassing inhibitors are also described, for example, in U.S. Pat. Nos. 6,872,489 and 7,169,504, and U.S. Patent Publication No. 2004/0076878, the entire contents of which are hereby incorporated by reference for all relevant purposes, to the extent they are consistent with the present disclosure.

When used, the amount of corrosion or gassing inhibitor present in the gelled anode may be determined or selected to optimize performance of the anode. Typically, however, the concentration of the inhibitor in the gelled anode will be at least about 10 ppm, about 25 ppm, about 50 ppm, about 100 ppm, about 150 ppm, about 200 ppm or more. Typically, however, the concentration is in the range of about 10 to about 150 ppm, or about 15 to about 50 ppm, when for example a phosphate-type corrosion or gassing inhibitor is used, while the concentration is in the range of about 20 to about 180 ppm, or about 75 to about 150 ppm, when for example an amphoteric-type inhibitor is used.

D. Electrolyte Preparation

The electrolyte may be prepared using methods generally known in the art. In accordance with the present disclosure, this preparation may for example involve forming an aqueous solution of a metal hydroxide salt, such as potassium, lithium or sodium hydroxide, and optionally a portion of the gelling agent (as detailed elsewhere herein). The electrolyte solution itself may comprise, for example, from about 20% to about 50%, and desirably from about 25% to about 40% of a hydroxide salt (e.g., potassium hydroxide), based on the total weight of the electrolyte.

The electrolyte fabrication process may include adding zinc oxide to the electrolyte solution, for example to reduce dendrite growth, which in turn reduces the potential for internal short circuits by reducing the potential for separator puncturing. Although in at least some of the embodiments described herein, the zinc oxide need not be provided in the electrolyte solution, as an equilibrium quantity of zinc oxide is ultimately self-generated in situ over time by the exposure of zinc to the alkaline environment and the operating conditions inside the cell, with or without the addition of zinc oxide per se. The zinc used in forming the zinc oxide is drawn from the zinc already in the cell, and the hydroxide is drawn from the hydroxyl ions already in the cell. Where zinc oxide is added to the electrolyte solution, the zinc oxide is typically present in an amount of from about 0.5% to about 4%, or about 1% to about 2%, based on the weight of the electrolyte solution, and may in some embodiments be about 2% by weight.

As previously noted, the gelled anodes of the present disclosure may also employ an absorbent (i.e., superabsorbent), and in at least some embodiments typically employ such an absorbent.

E. Gelled Anode Fabrication

The gelled anode may generally be prepared using means known in the art. The gelled anode contains an anode active material, the concentration of which is typically, for example, between about 50% and about 80% by weight, about 55% to about 75% by weight, or from about 60% to about 70% by weight, based on the total weight of the gelled anode. In general, the anode active material, which is typically in particulate or powder form, can be any suitable anode active material that is known to be used in electrochemical cells having an aqueous alkaline environment. Desirably, the metal alloy is a powder that contains zinc.

### III. Cathode

In accordance with one or more embodiments of the present disclosure, a cathode suitable for use in an alkaline electrochemical cell as detailed herein may comprise at least one cathode active material. Other optional components, such as a binder, may be present in the cathode mixture, as well. The cathode active material may be amorphous or crystalline, or a mixture of amorphous and crystalline, and may be essentially any material generally recognized in the art for use in alkaline electrochemical cells. For example, the cathode active material may comprise, or be selected from, an oxide of copper, an oxide of manganese (e.g., EMD, CMD, NMD, or a mixture of two or more thereof), an oxide of silver, and/or an oxide or hydroxide of nickel, as well as a mixture of two or more of these oxides or hydroxide. Suitable examples of positive electrode materials include, but are not limited to, MnO₂ (EMD, CMD, NMD, and mixtures thereof), NiO, NiOOH, Cu(OH)₂, cobalt oxide, PbO₂, AgO, Ag₂O, Ag₂Cu₂O₃, CuAgO₂, CuMnO₂, Cu Mn₂O₄, Cu₂MnO₄, Cu₃₋ₓMnₓO₃, Cu₁₋ₓMnₓO₂, Cu₂₋ₓMnₓO₂ (where x<2), Cu₃₋ₓMnₓO₄ (where x<3), Cu₂Ag₂O₄ and suitable combinations thereof.

In at least one embodiment of the present disclosure, the cathode mixture comprises an oxide of copper. In this regard it is to be noted that, as used herein, the term “copper oxide” is intended to refer to cupric oxide, where the copper has an oxidation state of about +2. Exemplary copper oxide compounds are set forth in greater detail herein below, as well as in U.S. patent application Ser. No. 11/354,729 (the entire content of which is incorporated herein by reference for all relevant purposes, to the extent it is consistent with the present disclosure).

Conventional cathodes may typically include a binder. In those embodiments wherein a conventional binder is employed, it is typically in powder or particulate form. Generally, any conventional binder suitable for use in a cathode in an alkaline electrochemical cell may be used, provided it is suitably compatible with the other components therein. Such binders may include, for example, polyethylene binders (e.g., (i) low density PE, such as low density PE grade 1681-1, commercially from DuPont, (ii) high density PE, (iii) a mixture of low and high density PE), polyvinyl alcohol binders, as well as mixtures of one or more thereof.

In general, the type and concentration of the cathode active material, or materials when a mixture is used, as well as the type and concentration of the other components that may optionally be present in the cathode, will be selected in order to optimize the overall performance of the electrochemical cell of which the cathode is a part. Typically, however, the concentration of the active material, or total concentration of active materials when a mixture is used, may be between about 70 wt % and less than about 100 wt %, based on the total weight of the cathode, and may be between about 75 wt % and about 95 wt %, or about 80 wt % and about 90 wt %, of the total cathode weight. For example, in various embodiments the concentration of the cathode active material may be about 70 wt %, about 80 wt %, or about 90 wt %, based on the total weight of the cathode.

### IV. Separator

Essentially any separator material and/or configuration suitable for use in an alkaline electrochemical cell, and with the cathode and/or anode materials set forth herein above, may be used in accordance with the present disclosure. In one embodiment, however, wherein one or more components of the electrochemical cell is capable of forming an anode fouling species in the cell, a separator as set forth in U.S. patent application Ser. No. 11/354,729 (the entire contents of which is incorporated herein by reference for all relevant purposes, to the extent it is consistent with the present disclosure), may be used. More particularly, one embodiment of the present disclosure includes a sealed separator system for an electrochemical cell that is disposed between a gelled anode of the type described here and a cathode containing soluble species of for example copper, silver, or both, as described above.

In this regard it is to be noted that the term “sealed separator system” is used herein to define a structure that physically separates the cell anode from the cathode, enables hydroxyl ions and water to transfer between the anode and cathode, limits transport other than through the material itself by virtue of a seam and bottom seal, and effectively limits the migration through the separator of other soluble species such as copper, silver, nickel, iodate, bismuth and sulfur species from the cathode to the anode. The choice of separator material and the need for a “sealed separator system” may depend, to some extent, upon the cathode active material in the cell, and whether or not anode-fouling species are produced. In a conventional alkaline cell using a manganese dioxide cathode where no significant anode fouling species are produced (other than those from minor trace impurities present), a film separator such as one made of polyvinyl alcohol or cellophane alone, in combination with each other, or in combination with a non-woven material may be used without a bottom or side seam seal so long as adequate measures are taken to prevent internal soft shorting by transport of fine particulates along or past the unsealed areas. The use of an adhesive, such as that described in for example U.S. patent application Ser. No. 11/058,665 (the entire contents of which is incorporated herein by reference for all relevant purposes, to the extent it is consistent with the present disclosure), may optionally be used to effectively limit the crossover between the anode and cathode compartments over the top of the separator, by bonding or sealing the separator with the sealing assembly and/or container of the electrochemical cell, to effectively minimize physical and/or chemical transport between the anode and the cathode compartments of the cell.

It is to be noted that, in one alternative embodiment, the present disclosure is directed generally to a conventional alkaline electrochemical cell, or alternatively to an alkaline electrochemical cell which comprises one or more components that may form an anode fouling species in the cell, which comprises a thin film separator, such as disclosed in U.S. patent application Ser. Nos. 10/914,934 and 11/354,729 (the contents of which are incorporated herein by reference for all relevant purposes, to the extent it is consistent with the present disclosure).

### V. Cell Types

It should be understood that the gelled anodes of the present disclosure may be added to essentially any anode in any type of electrochemical cell including, but not limited to, zinc-manganese dioxide cells, zinc-silver oxide cells, metal-air cells including zinc in the anode, nickel-zinc cells, rechargeable zinc/alkaline/manganese dioxide (RAM) cells, zinc-copper oxide cells, or any other cell having a zinc-based anode. It should also be appreciated that the present disclosure is applicable to any suitable button-type cell, and/or any suitable cylindrical metal-air cell, such as those sized and shaped, for example, as AA, AAA, AAAA, C, and D cells.

### VI. Cell Performance

As further detailed elsewhere herein, the electrochemical cells of the present disclosure have been observed to exhibit improved performance characteristics, which may be measured or tested in accordance with several methods under the American National Standards Institute (ANSI) including, for example, C18.1M, Part 1-2005. These tests include for example determining cell performance/longevity under situations of constant cell discharge, cell pulse discharge (i.e., repeated application of 1 A for a period of 10 seconds carried out every minute over the period of an hour per day), and intermittent cell discharge (i.e., a continuous discharge for repeated limited periods of time, for example one hour per day). Results of various tests of cells of the present disclosure are detailed below in the Examples.

The following Examples describe various embodiments of the present disclosure. Other embodiments within the scope of the appended claims will be apparent to a skilled artisan considering the specification or practice of the disclosure provided herein. It is therefore intended that the specification, together with the Examples, be considered exemplary only, with the scope and spirit of the disclosure being indicated by the claims, which follow the Examples.

### EXAMPLES

In the Examples presented below, data are provided which relate to the performance and reliability advantages when using the gelling agent detailed herein above as compared to a conventional gelling agent (Carbopol™). The performance gains observed, relative to the control cells, are shown to be the result of not only the use of electrolytes of low hydroxide (e.g., potassium hydroxide) concentrations in the gel, but also the use of the gelling agent of the present disclosure (e.g., Flogel™), in the specific tests performed (such as during discharge at 3.9 ohm 1-hour/day, at 1 A of pulse discharge, as well as during a continuous type of discharge, such as at 3.9 ohm in continuous mode).

Without being held to any particular theory, the performance advantages obtained with the gelling agent of the present disclosure (e.g., Flogel™) are thought to be the result of performance gains (induced by the gelling agent) in the anode discharge capacity. The benefit on the anode discharge capacity is believed to be attributable to the excess hydroxyl ion concentration, made available in the presence of this gelling agent generally and by virtue of improved reactant diffusion anticipated with this gelling agent. It is also currently believed that gelling agents of the present disclosure provide improved anode wettability, thereby allowing greater access of reactants to active sites of the anode.

In reference to the data shown below to demonstrate the effect of the present gelling agent on performance, the results reflect discharge performance to specific end point voltages (per the ANSI format), such as 0.8 V for testing at 3.9 ohm 1-hour/day, 1.05 V for the digital camera test, and 0.9 V for all other ANSI tests as well as continuous performance tests. For purposes of analyzing the effect of a variable, such as the presence of the present gelling agent or the potassium hydroxide concentration in the electrolyte of the gel, the average performance to the indicated end point voltages was tabulated for all available tests and respective formula conditions in accordance with standard and well-known statistical analysis. The results found to be statistically significant are realized by the p-value, an indicator of the magnitude of the significance. For example, for purposes of demonstration, it is to be noted that values considered statistically significant may be those with p-values equal or below 0.05 (the lower the value, the more definite the effect of a particular factor is). Large values (i.e., values approaching 1.0), suggest it may make no difference which variable is used between two conditions. Unless otherwise noted, performance is indicated in percentage relative to that of control cells set at a baseline 100%.

The results shown below also demonstrate that the present gelling agent has the advantage of suppressing cell gassing, particularly after partial discharge to the end point voltage of 1.0 V. Irrespective of the type of corrosion or gassing inhibitor used, the present gelling agent (e.g., Flogel™) is shown to advantageously depress cell gassing. This aspect is an important characteristic of the present gelling agent. It is well known that cell gassing is expected to increase with decreasing concentrations of KOH in the electrolyte of the gel. In view of the additional details provided below, it will become apparent that in the presence of the present gelling agent (e.g., Flogel™) cell gassing goes down even if the potassium hydroxide concentration is lowered, unlike the case observed with gels using a conventional gelling agent (e.g., Carbopol™), as noted in the interaction plots.

### Example 1

Gelled anodes including electrolytes containing potassium hydroxide at a concentration of 28%, 31%, or 34% by weight, zinc at concentrations ranging from 67 to 68% by weight, and each of two gelling agents (noted below) were prepared as detailed herein and incorporated into LR6 (size AA) and LR20 (size D) cells in accordance with methods generally known in the art. The two gelling agents used were:
(1) a polyacrylic acid gelling agent sold under the trade name Carbopol™ commercially available from Noveon, Inc., Cleveland, Ohio; and
(2) a polyacrylic acid gelling agent sold under the trade name Flogel™ 800 commercially available from SNF Holding Company (Riceboro, Ga.).
   The LR6 cells included a phosphate corrosion or gassing inhibitor sold under the trade name RM510, commercially available from Adco (Sedalia, Mo.), and the LR20 cells included an amphoteric surfactant sold under the trade name Mafo, commercially available from BASF (Mount Olive, N.J.).

The cells containing the Carbopol™ gelling agent also contained an absorbent sold under the trade name Alcasorb G-1, commercially available from Ciba Specialties (Carol Stream, Ill.). The weight ratio of gelling agent to absorbent was about 3:1.

The cathode materials for the LR6 cells and the LR20 cells were conventional, and commercially available, electrolytic manganese dioxide (EMD) powders prepared by electrolytic deposition of manganese dioxide from acid manganese sulfate solutions. The EMD powder used in the LR6 cell had a slightly coarser particle size distribution than the EMD powder used in the LR20 cell. Suitable EMD powders are described in, for example, U.S. Pat. No. 6,630,065, the entire contents of which are hereby incorporated by reference, to the extent that they are consistent with the present disclosure.

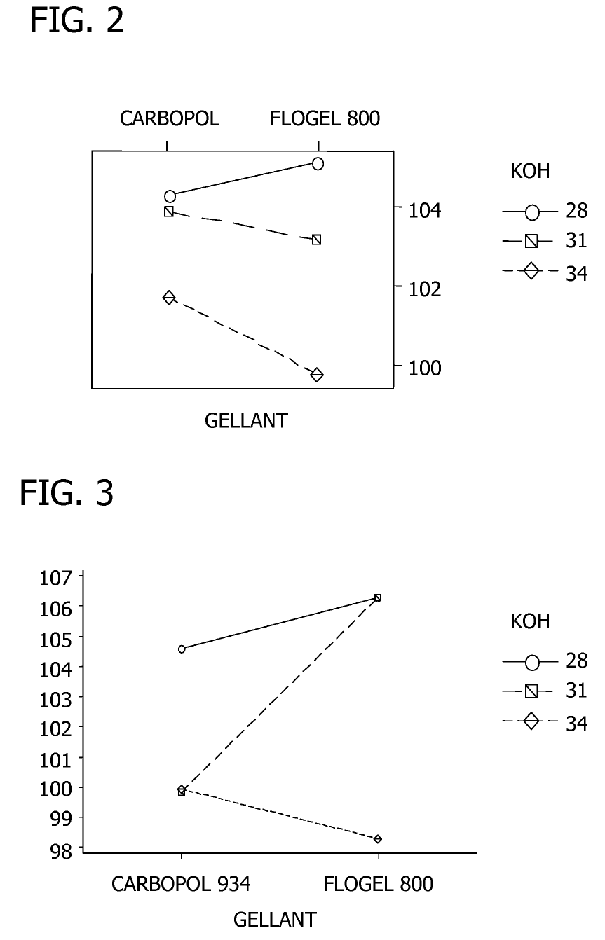

Eight ANSI tests (described in ANSI C18.1M, Part 1-2005) were conducted using the LR6 cells and five ANSI tests were conducted using the LR20 cells. The cells were tested at no delay condition after one week of room temperature storage. The results of these tests for the LR6 and LR20 cells are shown in FIGS. 2 and 3, respectively. The performance results shown in FIG. 2 correspond to the average of all eight ANSI LR6 tests and those shown in FIG. 3 correspond to the average of all five LR20 ANSI tests, relative to a control cell made with a Carbopol™-type gelling agent and a solution of 34% KOH (the y-axis numbers are percentages relative to the control for all the tests performed).

The results in FIG. 2 are for LR6 cells including anodes containing Carbopol™ 940 along with Salsorb™ absorbent at varying gelling agent/absorbent ratio and electrolytes of varying hydroxide content. The gelled anodes tested included (1) Carbopol™ 940 and Salsorb™ at a weight ratio of approximately 2.55:1 and an electrolyte containing approximately 34% by weight potassium hydroxide, (2) Carbopol™ 940 and Salsorb™ at weight ratio of approximately 2.62:1 and an electrolyte containing approximately 31% by weight potassium hydroxide, (3) Carbopol™ 940 and Salsorb™ at weight ratio of approximately 2.69:1 and an electrolyte containing approximately 28% by weight potassium hydroxide. The concentrations of Carbopol™ in these anodes were approximately 0.43% by weight, 0.45% by weight, and 0.46% by weight, respectively.

These results shown in FIG. 2 are also for LR6 cells including anodes containing Flogel™ at varying concentrations of gelling agent and electrolytes of varying hydroxide concentration, but without absorbent. These gelled anodes included (1) approximately 0.60% by weight Flogel™ and an electrolyte containing approximately 34% by weight potassium hydroxide, (2) approximately 0.62% by weight Flogel™ and an electrolyte containing approximately 31% by weight potassium hydroxide, (3) approximately 0.66% by weight Flogel™ and an electrolyte containing approximately 28% by weight potassium hydroxide.

The results shown in FIG. 3 are for LR20 cells including anode gels that contained Carbopol™ 934 without an absorbent, specifically anode gels containing (1) Carbopol™ 934 at a concentration of approximately 0.68% by weight and an electrolyte containing 34% by weight potassium hydroxide, (2) Carbopol™ 934 at a concentration of approximately 0.70% by weight and an electrolyte containing 31% by weight potassium hydroxide, and (3) Carbopol™ 934 at a concentration of approximately 0.71% by weight and an electrolyte containing 28% by weight potassium hydroxide. FIG. 3 also includes results for gelled anodes including Flogel™, but not including an absorbent, specifically anode gels containing (1) approximately 0.61% by weight Flogel™ and an electrolyte containing approximately 34% by weight potassium hydroxide, (2) approximately 0.62% by weight Flogel™ and an electrolyte containing approximately 31% by weight potassium hydroxide, and (3) approximately 0.64% by weight Flogel™ and an electrolyte containing approximately 28% by weight potassium hydroxide.

As shown here, maximum cell performance was observed with the combination of Flogel™ gelling agent and potassium hydroxide content of the electrolyte of 28% by weight.

Initial viscosities and densities of the gelled anodes used in the LR6 cells containing Carbopol 940 and Salsorb were (1) 284,000 cp and 3.03 g/cc (34% KOH electrolyte), (2) 294,000 cp and 2.99 g/cc (31% KOH electrolyte), and (3) 300,000 cp and 2.91 g/cc (28% KOH electrolyte).

Initial viscosities and densities of the gelled anodes used in the LR6 cells containing Flogel 800 were (1) 220,000 cp and 3.01 g/cc (34% KOH electrolyte), (2) 222,000 cp and 2.91 g/cc (31% KOH electrolyte), and (3) 282,000 cp and 2.86 g/cc (28% KOH electrolyte). The viscosities of the gelled anodes containing Flogel increased by from approximately 20-45% after overnight aging.

Initial viscosities and densities of the gelled anodes used in the LR20 cells containing Carbopol 934 were (1) 366,800 cp and 2.97 g/cc (34% KOH electrolyte), (2) 356,800 cp and 2.94 g/cc (31% KOH electrolyte), and (3) 358,000 cp and 2.94 g/cc (28% KOH electrolyte).

Initial viscosities and densities of the gelled anodes used in the LR20 cells containing Flogel 800 were (1) 232,800 cp and 2.96 g/cc (34% KOH electrolyte), (2) 288,000 cp and 2.94 g/cc (31% KOH electrolyte), and (3) 300,000 cp and 2.83 g/cc (28% KOH electrolyte).

### Example 2

This example details testing of the continuous discharge performance of the LR6 and LR20 cells described in Example 1.

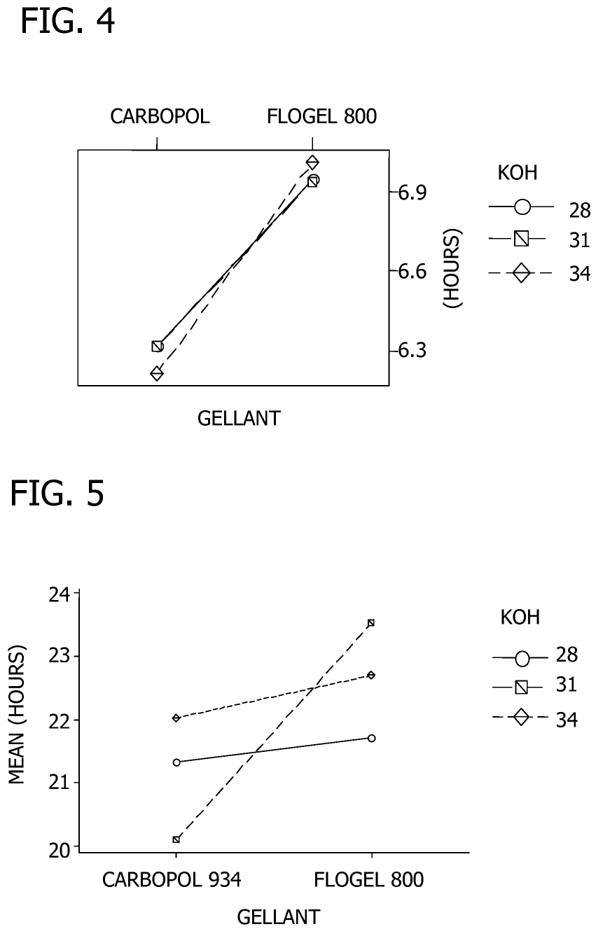

The LR6 cells were tested under conditions of continuous discharge at 3.9 ohms and the time to reach 0.9 V (hours) was determined as an indicator of cell performance. The LR20 cells were tested under conditions of continuous discharge at 2.2 ohms and the time to reach 0.9 V (hours) was determined as an indicator of cell performance. The results for the LR6 and LR20 cells are shown in FIGS. 4 and 5, respectively. As shown in FIG. 4 (S=0.128550, R-Sq=97.78%, R-Sq(adj)=87.77%), cell performance was independent of potassium hydroxide content, but cell performance increased at each potassium hydroxide concentration for the Flogel™ gelling agent as compared to the performance for the Carbopol™ gelling agent. FIG. 5 shows improved performance with the Flogel™ gelling agent at each potassium hydroxide concentration, and the highest performance for the Flogel™ gelling agent at a potassium hydroxide concentration of 31% by weight.

### Example 3

This example details cell gassing results (ml of gas evolved) after partial discharge performance tests of the LR6 and LR20 cells prepared as described in Example 1. The LR6 cells were discharged continuously at 3.9 ohms until the cell voltage reached 1V during discharge. The LR20 cells were discharged continuously at 2.2 ohms until the cell voltage reach 1V during discharge. After discharge to 1V, the cells were stored in a dry environment at approximately 71° C. (160° F.) for one week, and then allowed to cool to room temperature before being punctured in a water environment to capture the amount of gas accumulated during storage after partial discharge.

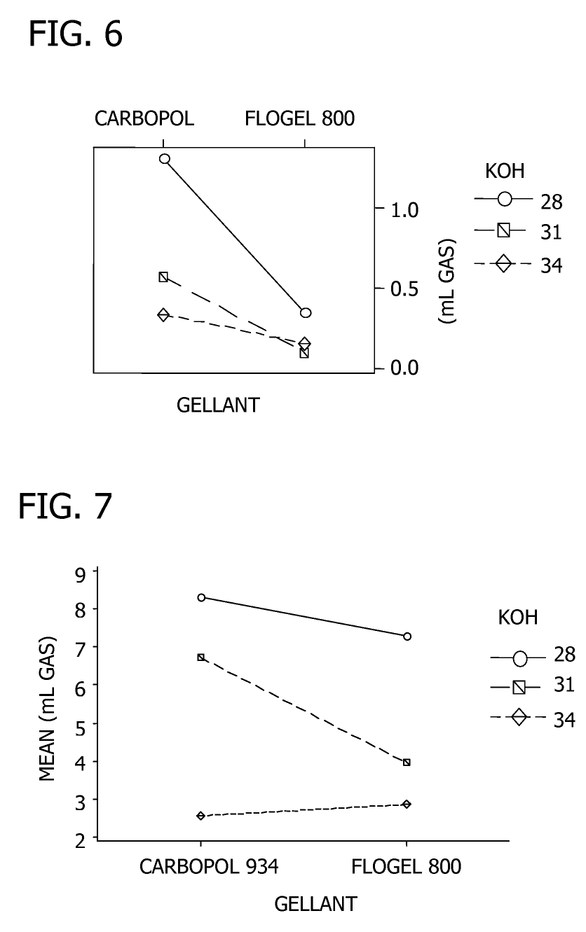

As shown in FIG. 6, for LR6 cells, use of the Flogel™ gelling agent provided reduced cell gassing at each level of potassium hydroxide content. FIG. 7 shows reduced cell gassing for the Flogel™ gelling agent at potassium hydroxide contents of 28% and 31% by weight.

### Example 4

Gelled anodes including electrolytes containing potassium hydroxide at concentrations ranging from 28 to 34% by weight, zinc at concentrations ranging from 67 to 68% by weight, and each of two gelling agents (noted below) were prepared as detailed herein and incorporated into LR6 (size AA) cells in accordance with methods generally known in the art. The two gelling agents used were:
(1) a polyacrylic acid gelling agent sold under the trade name Carbopol™ commercially available from Noveon, Inc., Cleveland, Ohio; and
(2) a polyacrylic acid gelling agent sold under the trade name Flogel™ 800 commercially available from SNF Holding Company (Riceboro, Ga.).

The gelled anodes of the LR6 cells included a phosphate-containing corrosion or gassing inhibitor (RM510). The cathode materials for the LR6 cells were conventional, and commercially available, electrolytic manganese dioxide (EMD) powders prepared by electrolytic deposition of manganese dioxide from acid manganese sulfate solutions.

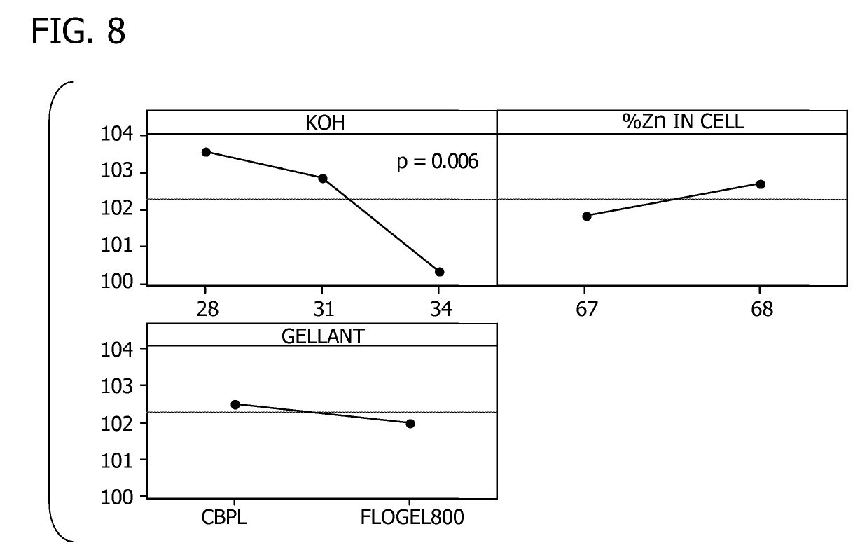

The cells were tested in all eight ANSI tests after storage of the cells at room temperature for three months. These ANSI tests are described in ANSI C18.1M, Part 1-2005. FIG. 8 (S=0.993871, R-Sq=79.29%, R-Sq(adj)=67.45%) shows the averages of the results of these tests (the y-axis numbers are percentages relative to the control for all the tests performed). As shown in FIG. 8, performance increased with decreasing potassium hydroxide concentration, and was not significantly affected by zinc concentration or the type of gelling agent.

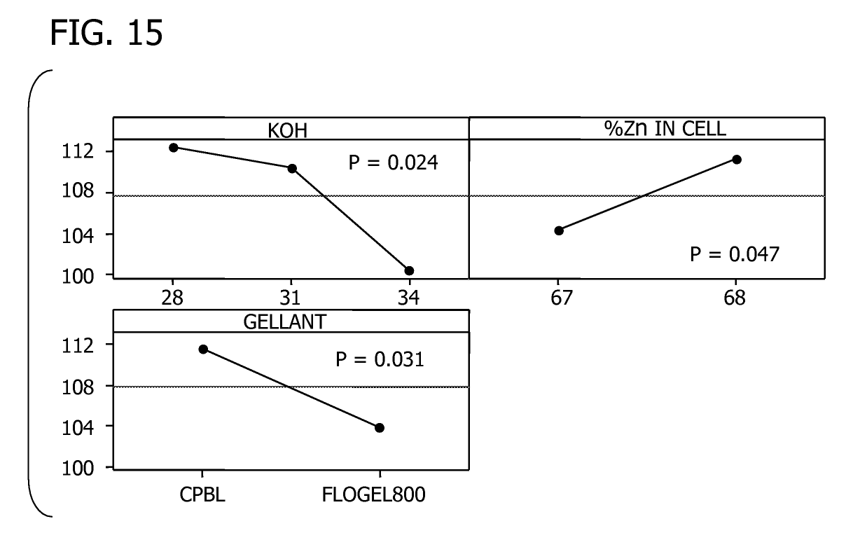

The cells described in this example were tested in the Digital Still Camera (DSC) test described, for example, in ANSI C18.1M, Part 1-2005 after three months of storage. The results are shown in FIG. 15 (S=4.97816, R-Sq=79.08%, R-Sq(adj)=67.13%) (the y-axis numbers are percentages relative to the control for all the tests performed).

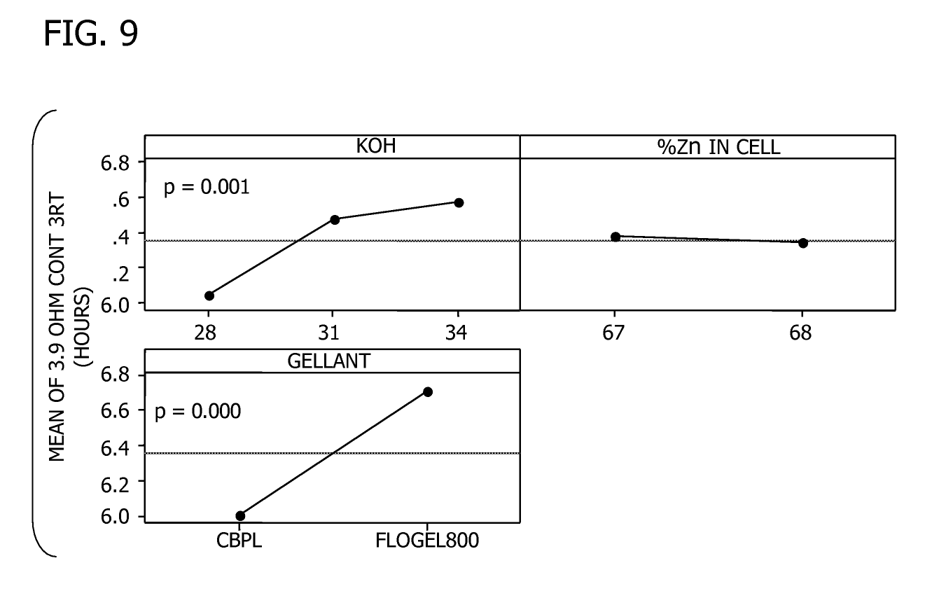

The cells described above in this example were also tested after three months of room temperature storage under continuous discharge conditions of 3.9 ohms and the time, in hours, to reach 0.9 V was used as an indicator of cell performance. These results are shown in FIG. 9 (S=0.126463, R-Sq=95.07%, R-Sq(adj)=92.25%). In contrast, FIG. 4 shows results of testing these cells under no-delay conditions (i.e., tested within one week of preparation of the cells).

As shown in FIG. 9, cell performance increased with increasing potassium hydroxide concentration. As with the results shown in FIG. 8, FIG. 9 shows that cell performance varied only slightly with varying zinc concentration, but also shows increased cell performance for the Flogel™ gelling agent as compared to the Carbopol™ gelling agent. It is currently believed that the improved cell performance of Flogel™ at increasing potassium hydroxide concentration is due, at least in part, to the anticipated greater availability of hydroxyl ion content with increasing potassium hydroxide concentration, as well as the improved access to anode reactants (e.g., hydroxyl ions) provided by this gelling agent.

### Example 5

This example details testing of cells and gelled anodes generally prepared as described in Example 4 that include three different grades of electrolytic manganese dioxide (EMD) powder, as a component of the cathode material. These powders constituted approximately 90 weight % of the cathode. The powders tested are labeled EMD1, EMD2, and EMD3 and are of the type prepared by means generally known in the art including, for example, as described in U.S. Pat. No. 6,630,065.

The cells containing the Carbopol™ gelling agent also contained an absorbent sold under the trade name Alcasorb G-1 and commercially available from Ciba Specialty (Carol Stream, Ill.). The weight ratio of gelling agent to absorbent was 3:1. The cells containing Flogel™ 800 gelling agent also contained Alcasorb G-1, but the weight ratio of gelling agent to absorbent was 12:1.

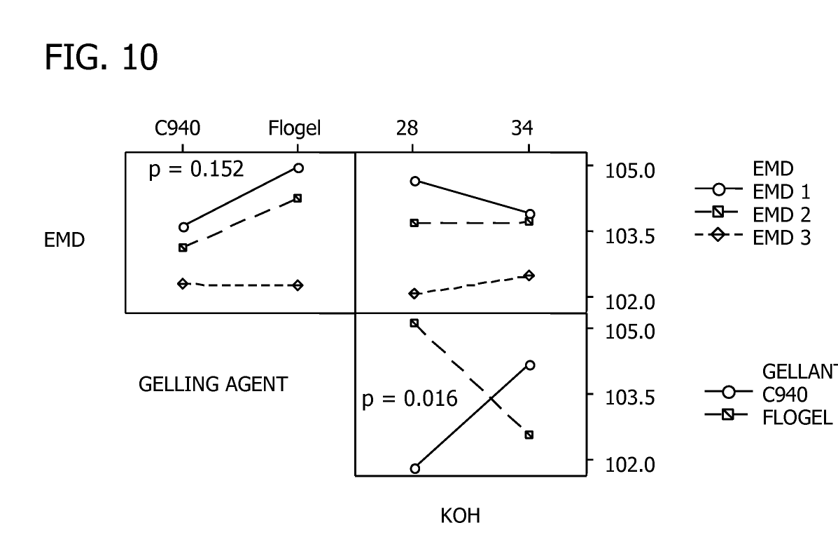

Eight ANSI tests (described in ANSI C18.1M, Part 1-2005) were conducted after storage of each of the three types of cells at room temperature for one week. The cells were tested under the conditions set forth above in Example 1. The average performance of all ANSI test results are plotted and shown in FIG. 10 (S=1.28774, R-Sq=74.50%, R-Sq(adj)=53.25%) (the y-axis numbers are percentages relative to the control for all the tests performed).

As shown in FIG. 10, maximum cell performance was observed with Flogel™ at lower potassium hydroxide concentrations. In particular, the increase in performance associated with lower electrolyte potassium hydroxide concentrations was greater for Flogel™ than Carbopol™. FIG. 10 also shows that cell performance with Flogel™ increased for the cells prepared using EMD1 at lower electrolyte potassium hydroxide concentrations (e.g., near 28% by weight) and was substantially constant for the cells prepared using EMD2 at lower potassium hydroxide concentrations. Cell performance decreased slightly at lower electrolyte potassium hydroxide concentrations for cells prepared using EMD3.

Overall, these results generally indicate improvement in average ANSI performance at lower electrolyte potassium hydroxide concentration (e.g., near 28% by weight), and greater improvement at lower electrolyte potassium hydroxide concentrations for the Flogel™ gelling agent. The best performance is observed for Flogel™ at or near potassium hydroxide concentration of 28% by weight.

The results shown in FIG. 10 indicate a difference in performance between EMD1 and EMD3, particularly at 28% potassium hydroxide concentration, and are currently believed to indicate that the Flogel™ additive has the overall effect of enhancing cell discharge capacity in a manner that is proportional to the discharge capacity of the corresponding cathode powder. Thus, the intrinsic performance difference between the EMD1 and EMD3 powders is currently thought to be primarily reflective of the difference in their discharge capacity. ANSI test results that involved increased performance for anode gels including 28% potassium hydroxide electrolytes and Flogel vs. those containing Carbopol (at performance increases ranging from about 0.5% to about 8%) included those for tests that involved discharge at 3.3 ohm for 4 min/hr for 8 hr/day, 250 mA for 1 hr/day, 100 mA for 1 hr/day, 43 ohm for 4 hr/day, and 24 ohm for 15 sec/min for 8 hr/day.

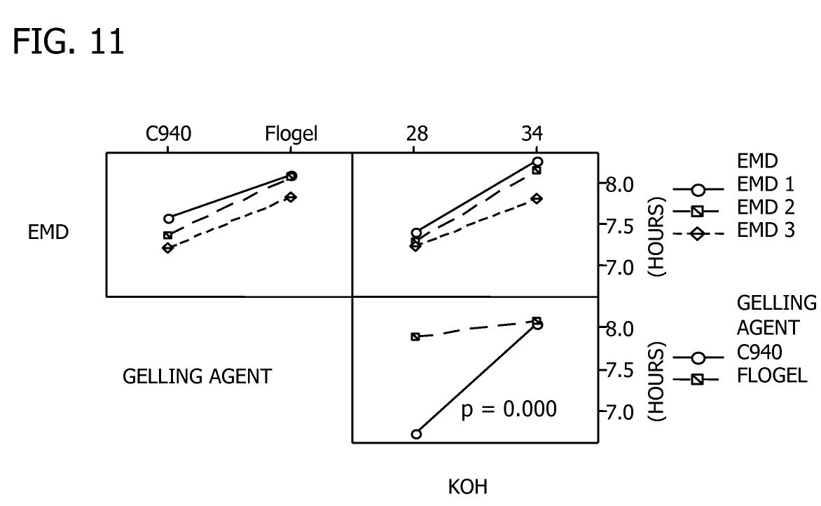

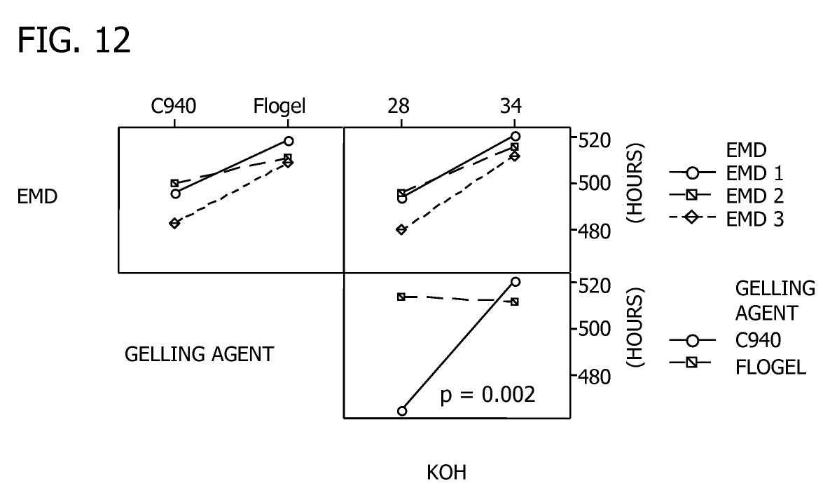

FIGS. 11 and 12 show results of tests involving discharge at 3.9 ohm for one hour/day, in hours of discharge, and at 1 A of pulse discharge for 60 cycles/day over the course of between 8 and 9 days, respectively, for these cells.

FIG. 11 (S=0.121209, R-Sq=97.92%, R-Sq(adj)=96.19%) generally shows improved performance for Flogel™ with each of the three EMD powders and also shows improved performance for Flogel™ over Carbopol™ at lower levels of potassium hydroxide content.

FIG. 12 (S=9.83506, R-Sq=91.54%, R-Sq(adj)=84.49%) shows trends similar to those shown in FIG. 11. In particular, improved performance for Flogel™ over Carbopol™ at lower levels of potassium hydroxide content was observed.

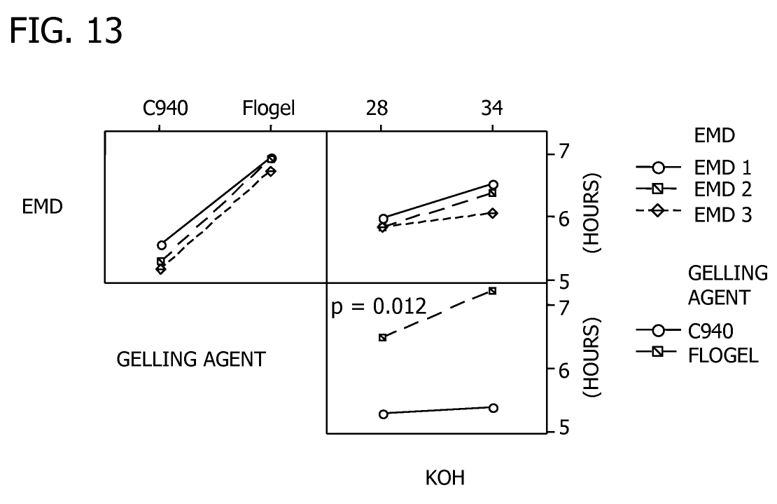

FIG. 13 (S=0.0614410, R-Sq=99.91%, R-Sq(adj)=99.50%) shows continuous discharge results, in hours of discharge, for cells prepared as described above in this Example, also including RM510 phosphate-containing corrosion or gassing inhibitor. The results shown in FIG. 13 indicate improved performance for Flogel™ over Carbopol™ over the entire range of potassium hydroxide content. Capacity during continuous discharge is generally believed to be affected by the anode reaction involving hydroxyl ions consumption and generation of a discharged product. Thus, during continuous discharge, in particular at relatively high rates of continuous discharge, a greater availability of hydroxyl reactants is currently believed to be necessary to enhance discharge capacity. It is currently believed that improved performance of Flogel™ during continuous discharge is due, at least in part, to enhanced access to hydroxyl reactants throughout the anode gel. It is also currently believed that the Flogel™ additive provides enhanced anode wettability leading to a greater access of electrolyte reactants, including access to the corrosion or gassing inhibitor surfactant, thus contributing to suppression of cell gassing.

As described elsewhere herein, physical characteristics of the anode gel containing Flogel™ (e.g., viscosity and/or density) are currently believed to contribute to this improved performance. For example, Flogel™ generally provides anode gels having greater viscosities than anode gels containing Carbopol™. In particular, Flogel™ is currently believed to provide gelled anodes having greater initial viscosities and/or greater viscosities after storage for a period of, for example, 8 hours to 20 hours. This increased gelled anode viscosity is currently believed to be accompanied by a change in gel appearance to a gelled anode having a more rigid-like form and having a slightly lower density than gelled anodes containing conventional gelling agents.

Gelled anodes including 28% potassium hydroxide electrolytes and containing Flogel™ at a gelling agent/superabsorbent ratio of approximately 12:1 exhibited an initial viscosity of approximately 268,000 cp while gelled anodes containing Carbopol at a gelling agent/superabsorbent ratio of approximately 3:1 exhibited an initial viscosity of approximately 260,000 cp. The anode gel containing Carbopol™ had an overnight viscosity (i.e., viscosity after storage for approximately 15 to 20 hours) of approximately 280,000 cp and the anode gel containing Flogel™ had an overnight viscosity of approximately 340,000 cp. These results indicate a greater thickening effect for a Flogel gelling agent/superabsorbent ratio of 12:1 as compared to that associated with Carbopol at a gelling agent/superabsorbent ratio of 3:1.

### Example 6

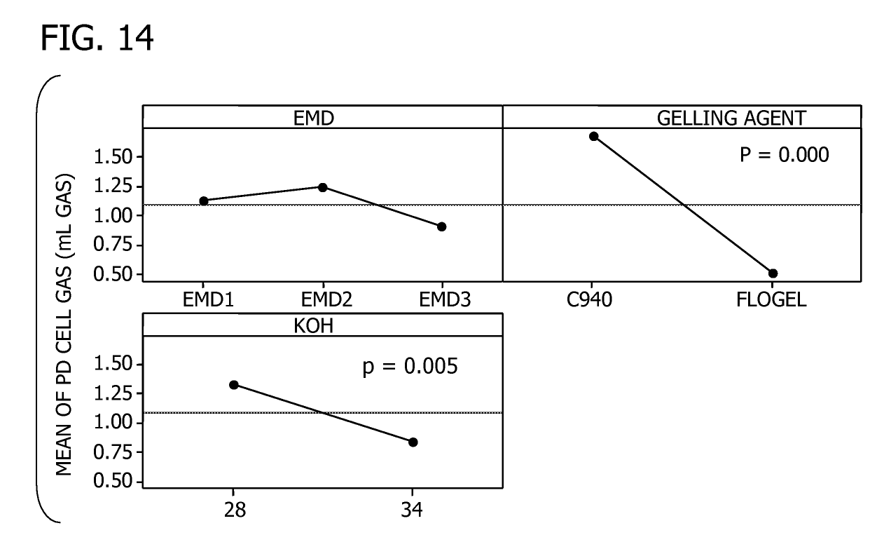

This example details cell gassing results for the cells prepared as described in Example 5, including each of the three EMD powders (EMD1, EMD2, and EMD3). The cells were tested under the conditions described above in Example 3. The results are shown in FIG. 14 (S=0.211784, R-Sq=94.12%, R-Sq(adj)=90.76%).

As shown in FIG. 14, ml of gas evolved, the Flogel™ gelling agent provided decreased cell gassing. It is currently believed that these advantageous cell gassing results are due, at least in part, to a greater access of the organic corrosion or gassing inhibitor to the corrosion sites. This is similar to a currently held mechanism for improved performance in which it is believed that improved performance associated with Flogel™ is believed to be due to improved accessibility of the reactants to the anode active sites.

### Example 7

This example details LR6 (size AA) and LR20 (size D) cells containing gelled anodes of various compositions, and their performance under various conditions. The compositions of the gelled anodes, various features of the gelled anodes (e.g., viscosity), and cell performance are detailed below in Table 1. Based on the performance of the cells containing the 30% KOH, Flogel™ 800 and 30% KOH, Carbopol™ 940 gelled anodes, the results in Table 1 indicate generally improved performance with the gelling agent of the present disclosure. The results in Table 1 also indicate improved cell performance with higher gelling agent to superabsorbent ratio (as evidenced by the results for the cells containing the 28% KOH, Flogel™ 800 and 28% KOH, Carbopol™ 940 gelled anodes). The results in Table 1 for the LR20 cells including anode gels containing a 30% potassium hydroxide electrolyte indicate lower gel gassing and cell gassing for gels and cells including Flogel™ 800 as compared to those including Carbopol™ 934.

TABLE 1

| | Cell Size | | | |
|---|---|---|---|---|
| | LR6 | LR6 | LR20 | LR20 |
| | Gel Description | | | |
| | | | 30% KOH, | |
| | 28% KOH, | 28% KOH, | Carbopol ™ | 30% KOH, |
| | Carbopol ™ 940 | Flogel ™ 800 | 934 | Flogel ™ 800 |
| Electrolyte, | | | 33.230% | 33.295% |
| 30-2 KOH—ZnO solution | | | | |
| (30% by weight potassium | | | | |
| hydroxide/ | | | | |
| 2% by weight zinc oxide) | | | | |
| Electrolyte, | 32.257% | 32.181% | | |
| 28-2 KOH—ZnO solution | | | | |
| Indium hydroxide | 0.010% | 0.010% | 0.015% | 0.015% |
| Ohka-Seal B | 0.099% | 0.099% | | |
| Carbopol ™ 934 | | | 0.695% | |
| (30,500–39,400 cps in 0.5% | | | | |
| aq. Sol.) | | | | |
| Carbopol ™ 940 | 0.450% | | | |
| (47,000–57,000 cps in 0.5% | | | | |
| aq. Sol.) | | | | |
| Flogel ™ 800 | | 0.637% | | 0.630% |
| (58,000–70,000 cps in 0.5% | | | | |
| aq. Sol.) | | | | |
| Alcosorb (superabsorbent) | 0.160% | 0.050% | | |
| Mafo Mod 13 (corrosion | | | 0.060% | 0.060% |
| inhibitor) | | | | |
| RM510 (corrosion or gassing | 0.024% | 0.024% | | |
| inhibitor) | | | | |
| Zinc alloy | 67.000% | 67.000% | | |
| (500 ppm Pb—120 ppm Bi) | | | | |
| Zinc alloy | | | 66.000% | 66.000% |
| (500 ppm Pb—60 ppm Bi) | | | | |
| TOTAL WEIGHT | 100.000% | 100.000% | 100.000% | 100.000% |
| Gelling agent/Absorbent ratio | 2.8 | 12.7 | | |
| Gel weight | 5.998 | 5.962 | 36.572 | 36.542 |
| Zinc weight | 4.01866 | 3.99454 | 24.137 | 24.117 |
| Zinc capacity (mAh) | 3295.3012 | 3275.5228 | 19792.34 | 19775.94 |
| Gel gassing, 3 days | 8.99 | 10.35 | 14.13 | 4.22 |
| (μl/g/day) | | | | |
| Gel density | 2.85 | 2.84 | 2.86 | 2.86 |
| Gel viscosity, initial (cp) | 260,000 | 268,000 | 258,000 | 200,000 |
| Gel viscosity, overnight aged | 296,000 | 340,000 | | |
| (cp) | | | | |
| Undischarged cell gas (cm³) | 0.24 ± 0.05 | 0.30 ± 0.07 | 1.42 ± 0.53 | 0.64 ± 0.13 |
| Partial discharge cell gas | 2.16 ± 0.47 | 0.70 ± 0.14 | 8.44 ± 0.77 | 4.44 ± 0.15 |
| (cm³) | | | | |
| Discharge performance, | | | | |
| to 0.9 V (hours): | | | | |
| 3.9 ohm continuous | 5.43 ± 0.31 | 6.54 ± 0.12 | | |
| 3.9 ohm 1 hour/day | 6.80 ± 0.06 | 7.99 ± 0.25 | | |
| 250 mA 1 hour/day | 8.452 ± 0.054 | 8.831 ± 0.020 | | |
| 2.2 ohm continuous | | | 22.38 ± 0.85 | 23.88 ± 0.22 |
| 1.5 ohm 4 min/15 min 8 | | | 16.36 ± 0.30 | 16.83 ± 0.76 |
| hour/day | | | | |
| 600 mA 2 hour/day | | | 19.35 ± 0.12 | 20.20 ± 0.49 |
| 2.2 ohm 1 hour/day | | | 26.44 ± 0.92 | 28.89 ± 0.34 |

### Example 8

This example details the viscosity over time of various gelled anodes containing Flogel™ and an absorbent (Salsorb™) at varying concentrations. A gelled anode containing Carbopol™ along with Salsorb™ was also prepared and its viscosity tested. The gelled anodes tested included (1) Carbopol™ at a concentration of approximately 0.43% and Salsorb™ at a concentration of approximately 0.15% (i.e., a weight ratio of gelling agent to absorbent of approximately 3:1), (2) Flogel™ at a concentration of approximately 0.43% and Salsorb at a concentration of approximately 0.15%, (3) Flogel™ at a concentration of approximately 0.64% and Salsorb™ at a concentration of approximately 0.05% by weight (i.e., a gelling agent to absorbent ratio of approximately 13.5:1), (4) Flogel™ at a concentration of approximately 0.66%, and (5) Flogel™ at a concentration of approximately 0.61% and Salsorb at a concentration of approximately 0.05% (i.e., a gelling agent to absorbent ratio of approximately 12:1) (all concentrations are based on the total weight of the anode). Details of the composition of the gelled anode are provided below in Table 2.

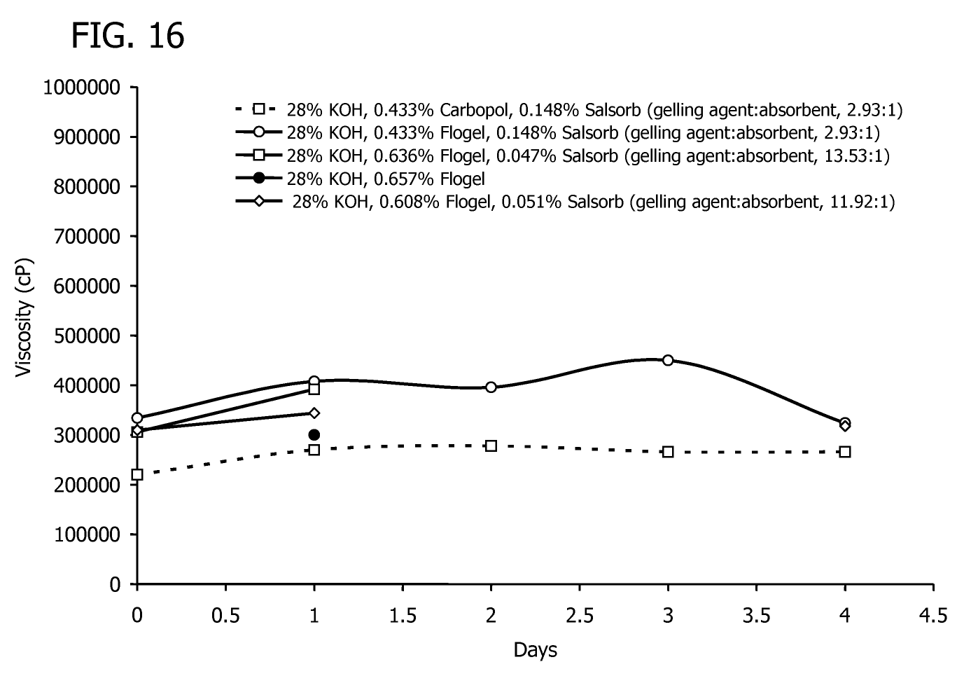

As shown in FIG. 16, at the same gelling agent to absorbent ratio (i.e., approximately 3:1), Flogel™ provides a higher initial viscosity (i.e., above 300,000 cp) and a higher viscosity after 4 days of storage (i.e., above 300,000 cp) than does Carbopol™.

TABLE 2

| Cell Size | LR6 | LR6 | LR6 |
|---|---|---|---|
| Gel Code Name | 0.433% | 0.636% | 0.657% |
| | Carbopol, | Flogel, | Flogel |
| | 0.148% | 0.047% | |
| | Salsorb | Salsorb | |
| Electrolyte, 28-2 | 31.29% | 31.183% | 31.211% |
| KOH—ZnO solution | | | |
| Indium hydroxide | 0.010% | 0.010% | 0.010% |
| Ohka-Seal B | 0.094% | 0.094% | 0.094% |
| Carbopol 940 | 0.433% | — | — |
| (47,000–57,000 cps | | | |
| in 0.5% aq. Sol.) | | | |
| Flogel 800 | | 0.633% | 0.650% |
| (58,000–70,000 cps | | | |
| in 0.5% aq. Sol.) | | | |
| Alcasorb, | 0.147% | 0.047% | — |
| superabsorbent | | | |
| RM510, corrosion or | 0.024% | 0.024% | 0.024% |
| gassing inhibitor | | | |
| Zinc alloy | 68% | 68.010% | 68.000% |
| TOTAL WEIGHT | 100.00% | 100.000% | 100.000% |
| Gelling | 2.94 | 13.57 | |
| agent/Absorbent ratio | | | |
| Gel density | 2.89 | 2.89 | 2.88 |
| Gel viscosity, | 234,000 | 392,000 | 400,000 |
| overnight aged (cp) | | | |
| Discharge | | | |
| performance, to 0.9 V | | | |
| 3.9 ohm continuous | 5.38 ± 0.09 | 6.30 ± 0.04 | 6.26 ± 0.20 |
| (Hours) | | | |

When introducing elements of the present disclosure or the various versions, embodiment(s) or aspects thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

In view of the above, it will be seen that the several advantages of the disclosure are achieved and other advantageous results attained. As various changes could be made in the above processes and composites without departing from the scope of the disclosure, it is intended that all matter contained in the above description and shown in the accompanying drawings shall be interpreted as illustrative and not in a limiting sense.

1. A gelled anode mixture, the mixture comprising a crosslinked polyacrylic acid gelling agent, an anode active material, and an alkaline electrolyte, wherein the gelled anode mixture has a viscosity of between at least about 300,000 cp and less than about 500,000 cp at 25° C.

2. (canceled)

3. The gelled anode mixture of claim 1, wherein the gelled anode mixture has a viscosity of from about 310,000 cp to about 475,000 cp at 25° C.

4. The gelled anode mixture of claim 1, wherein the gelled anode mixture has a density of at least about 2.5 g/cc.

5. (canceled)

6. The gelled anode mixture of claim 1, wherein the gelling agent is present in the gelled anode at a concentration of at least about 0.40%, based on the total weight of the gelled anode mixture.

7. (canceled)

8. The gelled anode mixture of claim 1, wherein anode active material is present in the gelled anode mixture at a concentration of from about 55% to about 75% by weight, based on the total weight of the gelled anode mixture.

9. The gelled anode mixture of claim 8, wherein the anode active material comprises zinc.

10. (canceled)

11. The gelled anode mixture of claim 1, wherein the alkaline electrolyte comprises water and potassium hydroxide.

12. The gelled anode mixture of claim 11, wherein the concentration of potassium hydroxide in the alkaline electrolyte is from about 25% to about 35% by weight, based on the total weight of the alkaline electrolyte.

13. The gelled anode mixture of claim 1, wherein the mixture further comprises an absorbent material.

14. The gelled anode mixture of claim 13, wherein the concentration of the absorbent material in the gelled anode mixture is from about 0.01% to about 0.2% by weight, based on the total weight of the gelled anode mixture.

15. The gelled anode mixture of claim 13, wherein the gelling agent and the absorbent material are present in the gelled anode mixture at a weight ratio of at least 3:1.

16. (canceled)

17. An alkaline electrochemical cell comprising:
a cathode;
a gelled anode mixture, the mixture comprising a crosslinked polyacrylic acid gelling agent, an anode active material, and an alkaline electrolyte, wherein the gelled anode mixture has a viscosity of between at least about 300,000 cp and less than about 500,000 cp at 25° C.; and,
a separator between the cathode and the anode.

18. The cell of claim 17, wherein the gelled anode mixture has a viscosity of at least about 350,000 cp at 25° C.

19. (canceled)

20. The cell of claim 17, wherein the gelled anode mixture has density of at least about 2.5 g/cc.

21. (canceled)

22. The cell of claim 17, wherein the gelling agent is present in the gelled anode mixture at a concentration of at least about 0.40%, based on the total weight of the gelled anode mixture.

23. (canceled)

24. The cell of claim 17, wherein anode active material is present in the gelled anode mixture at a concentration of from about 55% to about 75% by weight, based on the total weight of the gelled anode mixture.

25. The cell of claim 17, wherein the anode active material comprises zinc.

26. (canceled)

27. The cell of claim 17, wherein the alkaline electrolyte comprises water and potassium hydroxide.

28. The cell of claim 27, wherein the concentration of potassium hydroxide in the alkaline electrolyte is from about 25% to about 35% by weight, based on the total weight of the alkaline electrolyte.

29. The cell of claim 17, wherein the gelled anode mixture further comprises an absorbent material.

30. The cell of claim 29, wherein the concentration of the absorbent in the gelled anode mixture is from about 0.01% to about 0.2% by weight, based on the total weight of the gelled anode mixture.

31. The cell of claim 29, wherein the gelling agent and the absorbent material are present in the gelled anode mixture at a weight ratio of at least 3:1.

32. (canceled)

33. The cell of claim 17, wherein the cathode comprises a cathode active material comprising an oxide of copper, manganese, silver, nickel, or a mixture thereof.

34. The cell of claim 33, wherein the cathode comprises manganese dioxide.

35. (canceled)

36. A gelled anode mixture, the mixture comprising a crosslinked polyacrylic acid gelling agent, an anode active material, an alkaline electrolyte, and an absorbent material, wherein the gelling agent and the absorbent material are present in the gelled anode mixture at a weight ratio of at least 3:1.

37. The gelled anode mixture of claim 36, wherein the gelling agent and the absorbent material are present in the gelled anode mixture at a weight ratio of between at least 3:1 and about 25:1.

38. (canceled)

39. The gelled anode mixture of claim 36, wherein the gelled anode mixture has a viscosity of at least about 310,000 cp at 25° C.

40. (canceled)

41. (canceled)

42. (canceled)

43. (canceled)

44. (canceled)

45. (canceled)

46. (canceled)
